(19) United States
(12) Patent Application Publication
(10) Pub. No.: US 2016/0109181 A1
(43) Pub. Date: Apr. 21, 2016

(54) FURNACE FOR SMELTING COPPER FOR LOWER BLOW-THROUGH WITH ENRICHED OXYGEN

(71) Applicant: SHANDONG FANGYUAN NON-FERROUS SCIENCE AND TECHNOLOGY LIMITED COMPANY, Pudahuel, Santiago (CL)

(72) Inventors: Zhixiang CUI, Shandong Dongying (CN); Zhi WANG, Shandong Dongying (CN); Ruimin BIAN, Shandong Dongying (CN)

(21) Appl. No.: 14/894,439

(22) PCT Filed: May 30, 2014
(86) PCT No.: PCT/IB2014/061856

§ 371 Date: Nov. 27, 2015

(30) Foreign Application Priority Data
May 31, 2013 (CL) CL201301568

(51) Int. Cl. F27B 7/20; F27B 7/22; F27D 7/02; F27B 7/36; F27B 7/42; C22B 15/00; F27B 7/30

(52) U.S. Cl. CPC F27B 7/2083; C22B 15/0028; F27B 7/22; F27B 7/30; F27B 7/362; F27B 7/42; F27D 7/02; F27B 2007/367

(57) ABSTRACT

The invention describe facilities for smelting copper for a lower blow-through with enriched oxygen, comprising a furnace for lower blow-through, which, in turn, comprises the following characteristics:

A furnace body with a chamber and a partition inside, at least a supply inlet, a smoke outlet, a matte outlet, a slag outlet, at least one side opening for spray pistols, at least one lower opening for nozzles, and thermometer and level measurement openings;

At least one oxygen lance, arranged between the lower openings, for injecting oxygen into the chamber;

At least one side spray gun arranged inside the side openings in order to supply the chamber with coal dust or reductive gas.

### FIELD OF APPLICATION

This invention belongs to the application field of non-ferrous metallurgy and mainly to the application for copper, gold and silver concentrates and in addition to polymetallic associated minerals, which are refractory and of low grade. Copper, gold, silver and other precious and rare metals can be efficiently removed through this process and facilities, being a cost-efficient smelting technology with low emissions of carbon.

### BACKGROUND

Due to geographical factors and the differences among the existing concentrates according to their location, several types of copper smelting processes are used over the world, with the most popular pyrometallurgy processes being Flash Smelting (FS) and Smelting Bath (SB). Although all processes have advantages for which they are selected by the different companies, they also have faults from the technologies or restrictions to facilities that cannot be overcome.

The FS, for example, is not only selective as to the mineral components of the flow of minerals, but also the flow of mineral should be pretreated with deep drying, milling and pelletizing, all of which undoubtedly extends the process. Another problem is that the dry mineral reacts in suspending condition; thus, much dust is produced. A cover for the copper tanks is needed for the furnace to be cooled down, resulting in quite a high loss of heat and the increase of energy consumption.

In the SM processes, Noranda furnace for example and other ones with side blowing technology, blowing is just from one side. Under these circumstances, such problems arise as the gas and liquid being unable to be uniformly mixed; smelting blind spots are easy to form; spontaneous smelting cannot be performed; fuels should be consumed, etc. And especially in the side blowing process, the high temperature area is located at the net of gas flow. This makes the refractory material inside the furnace—especially the portion of gas flow inlet—to become exposed to the high temperature melting, shortening the life of the furnace and being limited to the rise of the oxygen concentration. In the processes with upper blowing, such as Mitsubishi and Isa, the gas is directly injected into the slag layer, In addition there are also such problems as the low efficiency of oxygen; the spontaneous smelting cannot be performed completely; lances are easily worn; reducing the size of the furnace is hard, etc. Regardless of the process being a side or upper blowing, there is a common problem—the slag peroxidation—with much Fe3O4 and highly viscous slag being produced, which involves a safety problem

In short, both in the FS and the SB, in the process of forming matte the temperature is over 1200° Celsius in order to ensure the smelting and discharge of the slag. Therefore, certain amount of solid, liquid or gaseous fuel should be charged in order to meet the demands of thermal balance and ensure production. But the increase of the smelting temperature shortens the furnace useful life dramatically. At the same time, the consumption of oxygen and the operating cost increase, more CO2 is produced and a number of energetic and environmental issues arise.

### TECHNICAL ADVANTAGES

The advantages of this invention are: treating poly-metallic complex minerals and with other precious and rare metals, as well as supplying complex minerals without milling, drying or pelletizing them in a shorter total process.

This invention has some other advantages. Oxygen is blown from the lower side of the furnace and directly injected in the layer of matte, where good fluidity exists. The good conditions of kinetic reactions and the convective heat, as well as the transfer of mass, contribute to the uniform removal of the molten material. Thus, the flow has a complete reaction without blind spots and the efficiency of oxygen use may reach 100%. The high temperature area is in the central section of the molten material, so that lances and refractory materials are subject to much less wear. With some special controls of the smelting process, a kind of protecting accrual can be formed in the form of mushrooms around the lance, thus extending the useful life of the latter. This process uses enriched oxygen and the wear problem of the oxygen lances is overcome; the smelting temperature is low, while the oxygen concentration is high and the amount of smoke from the furnace is small. Also, using the copper tank cover is not necessary to cool down the furnace, the loss of heat by unit of the furnace she is lower and consequently the total loss of heat is small, this being why no fuel is needed during the smelting process. The heat from the reactions of mineral material is enough to keep thermal balance, i.e. the spontaneous smelting is performed without carbon.

### DESCRIPTION OF FIGURES

The figures below help to understands the points and advantages mentioned above:

FIG. 1 corresponds to a view of the lower blow-through furnace according to one of the embodiments of this invention.

FIG. 2 corresponds to a longitudinal section of the furnace body shown in FIG. 1.

FIG. 3 corresponds to a cross-section of the furnace body shown in FIG. 1.

FIG. 4 corresponds to a view of the cylindrical lower blow-through furnace according to another embodiment of this invention.

FIG. 5 corresponds to a view of the lower blow-through furnace without the side spray guns and partition according to another embodiment of this invention.

FIG. 6 corresponds to a cross-section of the furnace body shown in FIG. 5.

FIG. 7 corresponds to a view of the lower blow-through furnace without the side spray guns and partition according to an embodiment of this invention.

FIG. 8 corresponds to a view of the lower blow-through furnace without the partition according to an embodiment of this invention.

FIG. 9 corresponds to the flowchart of the copper smelting process by blow-through under this invention.

### DETAILED DESCRIPTION OF THE INVENTION

First, the purpose of the invention is to present a copper smelting process with safe operation characteristics, good performance, energy saving and environmentally friendly.

Second, copper smelting facilities with enriched oxygen lower blow-though, good performance, simple manufacture, easy to operate and comfortable maintenance is shown.

According to the above, the copper smelting process by lower blow-through with enriched oxygen is shown through the lower blow-through furnace with oxygen and other associated facilities, including a furnace body (1) and at least an oxygen lance (7). In the furnace body there is a chamber, a partition (6) optionally arranged, a supply net (12), an outlet for the smoke (2), an outlet for matte (15) and an outlet for the slag (14). On a side of the body there are openings for spray guns (13) and openings for the oxygen lances on the bottom.

The stages of the process are as follows: (A) Supply the copper and auxiliary mineral after simple mixing directly from the supply net (12) to the chamber, without drying or pelletizing, so that the operation is simpler in a total process of lesser duration. (B) Injecting oxygen through the lances (7) mentioned above in order to smelt and inject coal dust or reductive gas through the side spray guns (13) in order to improve the smelting conditions and the slag characters. Since oxygen is injected from below, the reaction area is in the layer of matte on the low portion of smelting, where good fluidity, transfer of heat and mass exist and, therefore, stirring is uniform without blind spots and the oxygen use efficiency is high. As to the requirements of the follow-up process, the grade of the matte can be controlled not only at a low level of 45-69%, but also at the high level of 70-80%. (C) There is little oxygen in the as reaching the layer of slag, so that there is almost no peroxidation problem of said layer. A small amount of Fe₃O₄ in the layer of slag makes the slag to be of low viscosity and hard for a separation layer to be formed. The matte existing in the slag layer may settle easily. Therefore, the type of slag with a high phase of Fe/SiO₂ is practical and the proportion of flux and production of slag can be reduced, thus reducing the loss of copper in the slag to below 4% being obviously possible. (D) Expanded slag barely produced, thus being a safe procedure. Likewise, on the upper portion of lances (7) a kind of protecting accrual can be formed similar to mushrooms, which can greatly protect the lances (7), thus extending the useful life of the latter. Such productions as matte, slag and smoke are discharged through the outlets of matte (15), slag (14) and smoke (2) respectively.

According to the embodiment of the copper smelting process with enriched oxygen from this invention, the following results are obtained.

In one of the optimized embodiments, the grade of matte is 45-80%.

In the best embodiment, the grade of matte is 70-80%.

In one of the optimized embodiments, the content of copper in the slag can be controlled at ≦4%.

In one of the optimized embodiments, the smelting temperature can be controlled at ≦1180° C.

In one of the optimized embodiments, the oxygen concentration is of 20.5-99.5%.

In the best embodiment, the level of oxygen is 70-76%.

In one of the optimized embodiments, the pressure of oxygen injection is of 0.28-1.25 MPa.

In the best embodiment, the pressure of oxygen injection is of 0.45-0.65 MPa.

In one of the optimized embodiments, the slag is discharged in batches and as overflow.

The second concept of the invention is presenting a copper oxygen-enriched lower blow-through furnace and related facilities, including the furnace body (2), where there is a chamber with optional partition (6) and also a supply net (12), a smoke outlet (2), an outlet for matte (15), an outlet for the slag (14), a nozzle (10), an opening for temperature sensor (11) and an opening for measurement of level (3). On one side of the body (2) there are opening for spray guns (1) inserted in the corresponding openings for blowing coal dust and reductive gas and on the bottom there are openings for the oxygen lances (7) inserted in the corresponding openings and presented upwards to blow oxygen inside the chamber.

In one of the optimized embodiments, the inside body near the openings for lances (7) is lined with refractory bricks with lances inserted therein. The upper part of the lance is 0-2 cm higher than the lining.

In one of the optimized embodiments, the chamber bottom is flat.

In one of the optimized embodiments, the lances (7) are made of a special material and have a special structural design. Oxygen and protecting gas, respectively, are injected in them.

In one of the optimized embodiments, the furnace body (1) has the shape of cask or cylinder. The cross-section of the chamber is circular and its radial diameter is axially constant.

According to one of the optimized embodiments, the copper smelting furnace with oxygen-enriched lower blow-through includes at least a supporting bottom (5), gears (8) around the body (1), at least one supporting ring (4) over the bottom (5) around the body (1) and able to rotate connected to a driving unit (9) linked with the gear (8) to drive the body (1) and a copper tank cover only at the outlets of slag, matte and smoke in order to cool down some of the particular parts.

In one of the optimized embodiments, the supply inlet (12) and the smoke outlet (1) are in the upper part of the body and axially separated, while the slag outlet (14) is in the end surface.

In one of the optimized embodiments, the matte outlet (15) is in the lower part of the side wall along with the slag outlet (14) or in the opposing surface to the slag outlet.

In one of the optimized embodiments there are also openings for nozzles with jets (10), opening for thermocouple (11) and an opening for measurement of the level (3).

In one of the optimized embodiments, the angle of the opening for lances is −65≦α≦65°.

In one of the optimized embodiments, the lances (7) can be distributed in one line or more.

In one of the optimized embodiments, the spray guns (13) are in the side surface between the lances (7) and the furnace body (1) horizontally.

Compared with the current technologies, the positive effects of the present invention can be summed up as follows:

(A) The spontaneous smelting is fully achieved. The lower blow-through furnace is hermetically sealed with a small rate of air relief. Along with a high concentration of oxygen, the smelting intensity can be improved and less smoke produced.

Consequently, the drag of heat in the smoke is less and the loss of heat much lower; the structure of the furnace is simpler and the copper tank cover of the body is smaller, with its cylindrical shape helping to reduce the loss of heat. Based on this, the thermal balance is easy to keep without consumption of fuel, this meaning that fully spontaneous smelting can be achieved.

(B) Low-temperature smelting is performed. This lower bow-through process takes maximum advantage of its good mass and heat transfer and the good stirring caused by the high pressure of air injected from below to perform the low temperature smelting. It can not only save energy, but also to extend the useful life of furnace greatly.

(C) The full process is short with good adaptability of raw materials. Not only many types of copper, gold and silver concentrates can be treated, but also the polymetallic refractory, low grade mineral complexes, as well as the minerals resulting from associating precious metals with high grade of gold and silver, omitting the drying, milling and pelletizing processes, with which the process is greatly shortened.

(D) The process has high intensity smelting and is highly efficient in the use of oxygen. Oxygen is injected from below to the layer of matte, where good liquidity exists. The reaction area can be uniformly mixed without cyclones or blind spots, so that good transfer of heat and mass is formed and the oxygen use rate can reach up to 100%.

(E) The operation of this invention is safe and expanded slag is almost not produced, also having low content of copper in the slag. In this invention oxygen is blown from below directly to the matte layer and other materials are supplied to the reaction area on a continuous base, so that the oxygen pressure in the slag layer is low, this making the formation of Fe₃O₄ difficult. On the one hand, the type of slag with high rate of Fe/SO₄ is avowed and the proportion of flux can be reduced for less slag to be produced, while the viscosity of slag reduces. The mechanical dragging of copper is lower. This process in general reduces the loss of copper in the slag, improving the recovery of copper. Its operation is safer, since the low content of Fe₃O₄ in the slag restricts the formation of expanded slag.

(F) This invention makes it possible to operate with high amounts of enriched oxygen and both the lances and the refractory elements have long useful lives. The best concentration of oxygen is 70-76%. These lances are made of special materials and designed with a special structure with a scientific way of distribution. As a result thereof and since the reaction area is far from the lance outlet and the refractory lining, the useful life of furnace extends greatly.

According to that shown in the figures, the technical process can be summed up as follows: the concentrate (including the god, silver and copper concentrate and polymetallic mineral, etc.), the slag concentrate, powder, fluxes, etc. are placed in the furnace for production after simple mixing at the preparation shop. During production, the materials are charged on a continuous basis from the charging outlet located in the upper part. During the bathing, oxygen is injected from the oxygen station and air from the station of compressed air through supersonic lances from the low part of the furnace. Then, chemical reactions take place between the materials and the oxygen, producing gold-, silver- and copper-containing matte in addition to slag and smoke, which will come out through the outlets of matte, slag and smoke, respectively.

For a better understanding of the characteristics and advantages of this invention, a description will be presented in the form of embodiments and figures, although the embodiment is only for instruction and its use is not limited to the scope of the invention.

In this copper smelting process with oxygen-enriched lower blow-through, the concentrate of copper, quartz, reverse materials, stock, etc. are uniformly mixed and the mixture is placed in the furnace chamber on a continuous form through a conveyor. The hyperbaric oxygen and compressed air from the lances (7) in the low part of the furnace can stir the smelting bath sharply. The processes of transfer of heat and mass are very soon generated, and matte, slag and smoke at high temperature are produced. In the settling area, the molten material is divided in two layers: the upper one is slag and the lower one, matte. After going through the partition (6), the matte and the slag are found in the stable area behind the partition, where the copper and the slag may be easily separated. The coal dust supplied from the side spray guns (13) reduces the slag continuously in order to Improve the type of slag and reduce the copper content therein. Through the thermocouple opening (11) and the level measurement opening (3) located in the upper part of the furnace, the temperature of reaction and the smelting level can be monitored in real time. The slag, the matte and the smoke are allowed to leave trough their respective pipes. In some specific embodiments of this invention, the pressure of oxygen is 0.5-0.6 Mpa, the oxygen concentration inside the furnace is 73%, the average grade of matte is 73%, the average content of the slag is 3.5% and the smelting temperature can be controlled so that not to exceed 1,180° C.

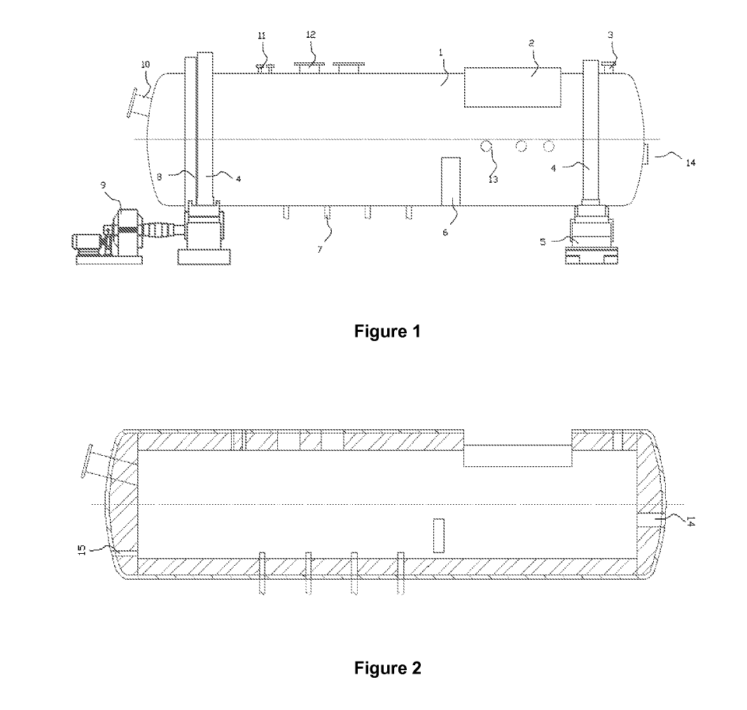

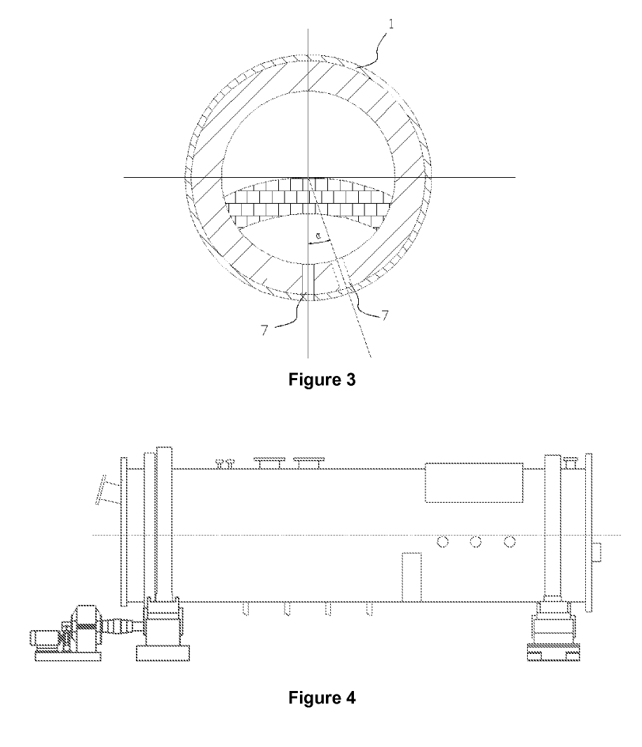

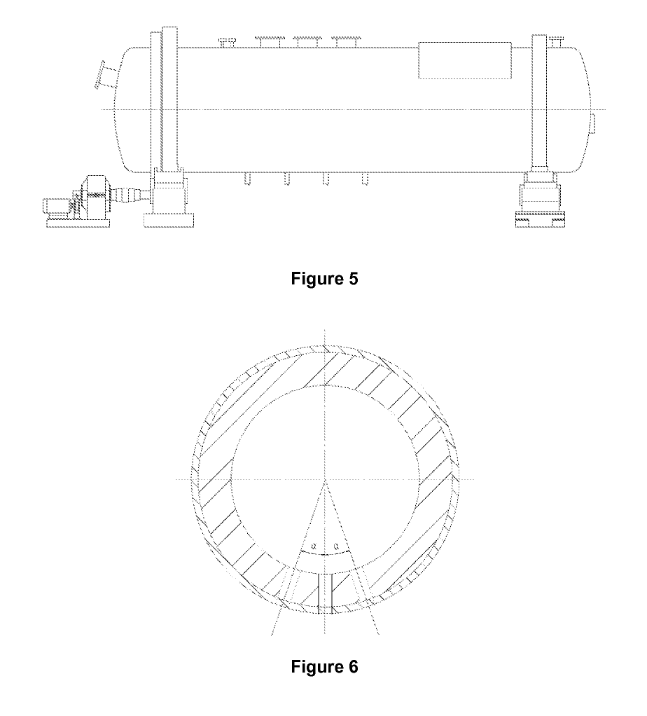

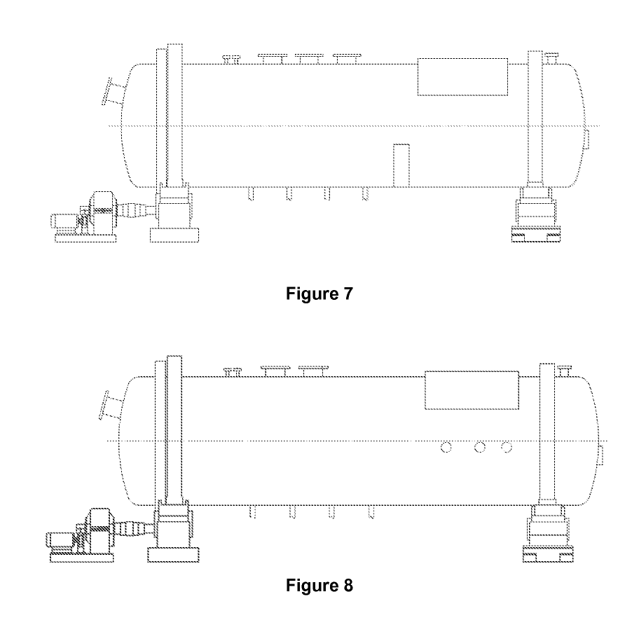

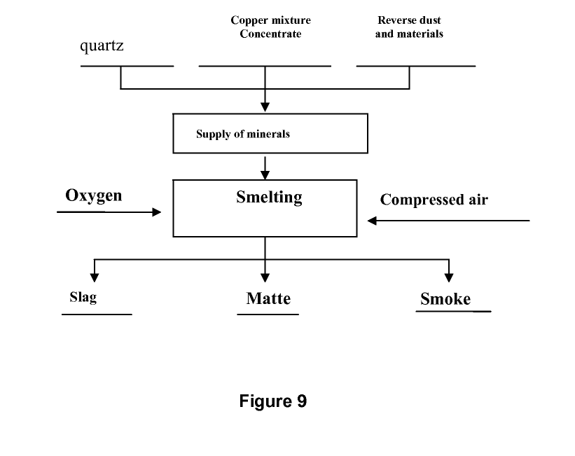

The installation mentioned has the shape of a cask or cylinder according to the front view shown in FIG. 1 and side view according to FIG. 2. The furnace can be designed with different length and diameter depending on the desired capacity of smelting, and the nozzles openings (10) are for the jets that can be integrated to improve the temperature when heating the furnace. For the smelting condition to be controlled, there are 3 to 5 openings for top loading (12) one opening for the thermocouple (11) and one opening for measurement of level (3), where a thermocouple and a steel needle can be embedded to measure the temperature and the level of molten material. The lances (7) are in the lower part, arranged in a row or crossing each other in two rows. All lances (7) are on one side of the furnace with the angle of −65≦α≦65 °, so that high pressure gas can be injected, In the chamber there is a partition (6), the matte flows from below and the slag from above; therefore, the flow becomes relatively static and helps to separate the slag from the matte. The slag outlet (14) is in the end wall near the settling area. The outlets can be protected with a tank copper cover. The outlet of copper can be set on the end or side wall with a copper tank cover as protection. Finally, the side spray guns (13) are used to supply the coal dust that improves the slag.

1. A copper smelting furnace for lower blow-through with enriched oxygen, wherein it comprises the following characteristics:
A body of the furnace with a chamber and partition inside, at least one supply inlet, a smoke outlet, a matte outlet, as slag outlet, at least one side opening for spray guns, at least one lower opening for lances and openings for thermometer and level measurements;
At least one oxygen lance inside the lower openings to inject oxygen into the chamber;
At least one side spray gun inside the side openings to supply coal dust or reductive gas to the chamber.

2. A copper smelting furnace for lower blow-through with enriched oxygen according to claim 1, wherein the lances are located at the same level or above the special bricks for lances or oar refractory lining.

3. A copper smelting furnace for lower blow-through with enriched oxygen according to claim 1, wherein the partition is located between the area of lances and the end of the slag outlet.

4. A copper smelting furnace for lower blow-through with enriched oxygen according to claim 1, wherein the furnace body has the shape of cask or cylinder and it can rotate, where the chamber cross-section is circular and the diameter of the section is constant the furnace's axial direction.

5. A copper smelting furnace fur lower blow-through with enriched oxygen according to claim 1, wherein the furnace can also includes at least a supporting base, at least a supporting ring, at least a gear and at least a driving device to allow rotation of the furnace.

6. A copper smelting furnace for lower blow-through with enriched oxygen according to claim 1, wherein the slag outlet is in the end wall of the furnace body, while the matte outlet is in the opposing end wall to the slag outlet or in the lower part of the side wall.

7. A copper smelting furnace fur lower blow-through with enriched oxygen according to claim 1, wherein the angles between the lances and the vertical line should be within −65α≦65°.
